(19) United States
(12) Patent Application Publication
(10) Pub. No.: US 2006/0235676 A1
(43) Pub. Date: Oct. 19, 2006

(54) Method for compressing audio data

(76) Inventors: Hsiu Chung Wu, Taipei City (TW); Chih Chiang Chou, Taipei City (TW); Tsu Yi Ku, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/391,441

(22) Filed: Mar. 29, 2006

(30) Foreign Application Priority Data
Mar. 30, 2005 (TW) 094110116

(51) Int. Cl. G06F 17/20

(52) U.S. Cl. 704/1

(57) ABSTRACT

A method for representing the items of a data, especially an audio data, by using fixed bits, is provided. The method can improve the speed to compress and decompress the data and reduce the load of the processor.

### BACKGROUND OF THE INVENTION

1. Field of the Invention

The present invention relates to a method and system for compressing a data stream, and particular to a method and a system for compressing audio data for transportation on wired or wireless network and storage on recording media.

2. The Related Arts

The rapid progress of network data transportation in recent years has prompted the development of a variety of data formats and communication protocols. The large amount of data transported through the network and stored in recording media also requires heavy investments. To improve the efficiency of data transportation and storage, an effective compression technology is one of the most pressing issues of the information industry.

Conventional techniques for data compression can be categorized into two types. The first is lossy compression, such as MP3, and the second is lossless compression, such as ZIP. The former can greatly reduce the amount of the data at the sacrifice of quality. The latter is unable to compress certain type of data, such as audio data.

At present, the differential pulse code modulation (DPCM) method is among the most effective methods for compressing audio data with a high compression ratio. In transforming analog signals into digital signals, the DPCM method computes a sample analog signal to obtain an estimate value for the next sample. Then, the difference between the estimate value and the actual value of the next sample is quantized and encoded into a digital signal.

The difference between the two consecutive samples is usually small for data having a high inter-dependence between the consecutive samples, such as audio data. Therefore, the DPCM method only requires fewer bits to represent individual sample and achieve a higher compression ratio.

In summary, the DPCM method relies on the estimation of the next sample in computing the previous sample signal. The present invention provides an estimation technique to obtain a high compression ratio.

In addition, for the conventional compression methods, including DPCM, the processor spends much effort in determining the length of difference of each sample segment during the decompression because the sample difference after the coding computation is varied. Also because of the varied length of each data, the processor spends much effort in determining the length of each data during the decompression.

Furthermore, many data streams, especially audio data streams, contain a lot of consecutives zeros, such as AC3, which padding the data stream with many zeros. This also increases the bits requires for transportation or storage.

It is, therefore, imperative to devise a compression method to obtain a higher compression ratio to reduce the data for transportation and storage. It is also important to have a compression method with fixed bits to improve the compression and decompression efficiency.

### SUMMARY OF THE INVENTION

The primary object of the present invention is to provide an improved data compression method and a system. By utilizing the inter-dependence between the two consecutive samples, the previous several samples are computed to obtain the estimation of the next sample. The difference between the actual value and the estimate value of the next sample is then encoded. The method and system of the present invention can use the minimum number of bits to represent each sample, so that the compression and decompression speeds increase.

Another object of the present invention is to provide a data representation method using a fixed number of bits to represent each item in a data so as to greatly increase the compression and decompression speeds and reduce the load on the processor.

Yet another object of the present invention is to provide a data representation method using a fixed-length segment to represent each segment in a data as to increase the compression ratio.

Yet another object of the present invention is to provide a compression method eliminating zeros from the data. By representing the consecutive zeros in the data stream, and eliminating the consecutive zeros, the data required for transportation and storage is reduced.

The present invention has the following advantages. First, the present invention is applicable to lossless compression methods; therefore, no audio quality is sacrificed. Second, the present invention effectively compresses audio data. And third, the present invention is applicable to multi-channel and various sample rates.

These and other objectives, features, and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention can be understood in more detail by reading the subsequent detailed description in conjunction with the examples and references made to the accompanying drawings, wherein:

FIGS. 1A and 1B show flowcharts of encoding and decoding of a compression method in accordance with a first embodiment of the present invention;

FIGS. 2A and 2B show flowcharts of encoding and decoding of a compression method in accordance with a second embodiment of the present invention;

FIGS. 3A and 3B show flowcharts of encoding and decoding of a compression method in accordance with a third embodiment of the present invention;

FIGS. 4A and 4B show flowcharts of encoding and decoding of a compression method in accordance with a fourth embodiment of the present invention;

FIGS. 5A and 5B show the data representation format of using fixed number of bits in accordance with a fifth embodiment of the present invention;

FIG. 6 shows data representation method of using fixed-length segment in accordance with a sixth embodiment of the present invention;

FIGS. 7A and 7B show a zeros elimination method in accordance with a seventh embodiment of the present invention; and

FIG. 7C shows a packet format of the zeros elimination method of the sevenths embodiment of the present invention.

### DETAILED DESCRIPTION OF BEST MODE FOR CARRYING OUT THE PRESENT INVENTION

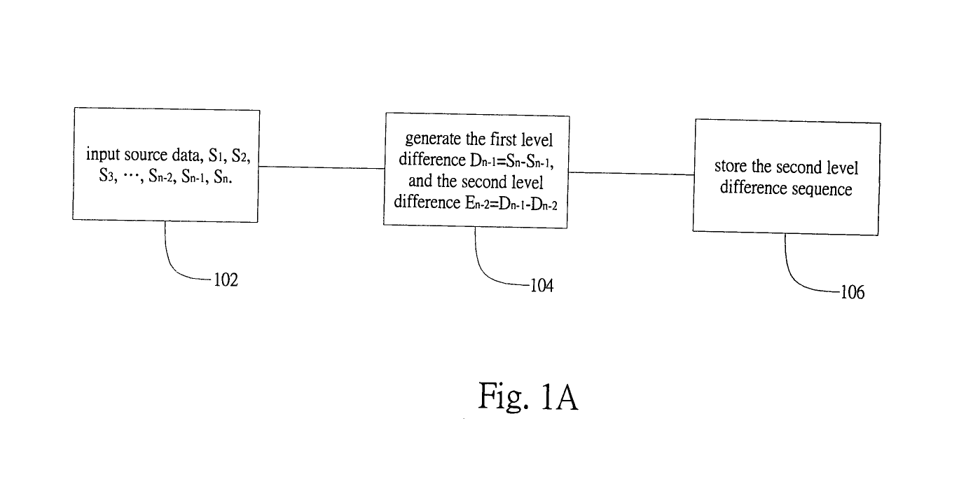

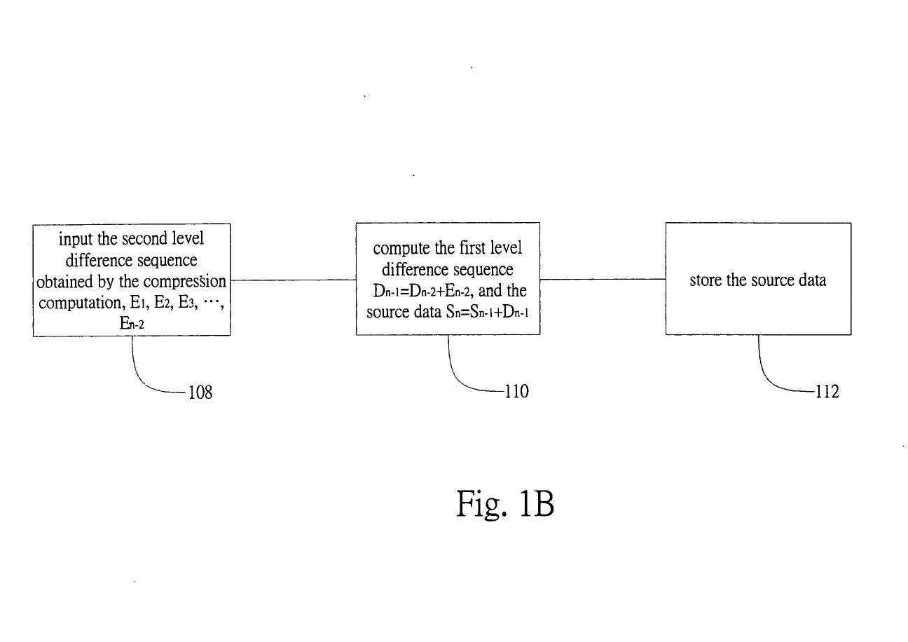

With reference to the drawings and in particular to FIGS. 1A and 1B, which show flowcharts of encoding and decoding of a compression method in accordance with a first embodiment of the present invention. As shown in FIG. 1A, step 102 is to input source data, S₁, S₂, S₃, . . . , Sₙ₋₂, Sₙ₋₁, Sₙ. Step 104 is to generate the first level difference Dₙ₋₁=Sₙ−Sₙ₋₁, and the second level difference Eₙ₋₂=Dₙ₋₁−Dₙ₋₂. Repeat the above computation to obtain the following sequences:

First level difference sequence: D₁=S₂−S₁, D₂=S₃−S₂, . . . , Dₙ₋₁=Sₙ−Sₙ₋₁;

Second level difference sequence: E₁=D₂−D₁, E₂=D₃−D₂, . . . , Eₙ₋₂=Dₙ₋₁−D_{n-2.}

And finally, step 106 is to store the second level difference sequence.

The decompression computation follows the reverse direction. As shown in FIG. 1B, step 108 is to input the second level difference sequence obtained by the compression computation, E₁, E₂, E₃, . . . , Eₙ₋₂. Step 110 is to compute the first level difference sequence Dₙ₋₁=Dₙ₋₂+Eₙ₋₂, and the source data Sₙ=Sₙ₋₁+Dₙ₋₁. Repeat the above computation to obtain the following sequences:

First level difference sequence: D₂=D₁+E₁, D₃=D₂+E₂, . . . , Dₙ₋₁=Dₙ₋₂+Eₙ₋₂;

Source data: S₂=S₁+D₁, S₃=S₂+D₂, . . . , Sₙ=Sₙ₋₁+Dₙ₋₁.

And finally, step 112 is to store the source data.

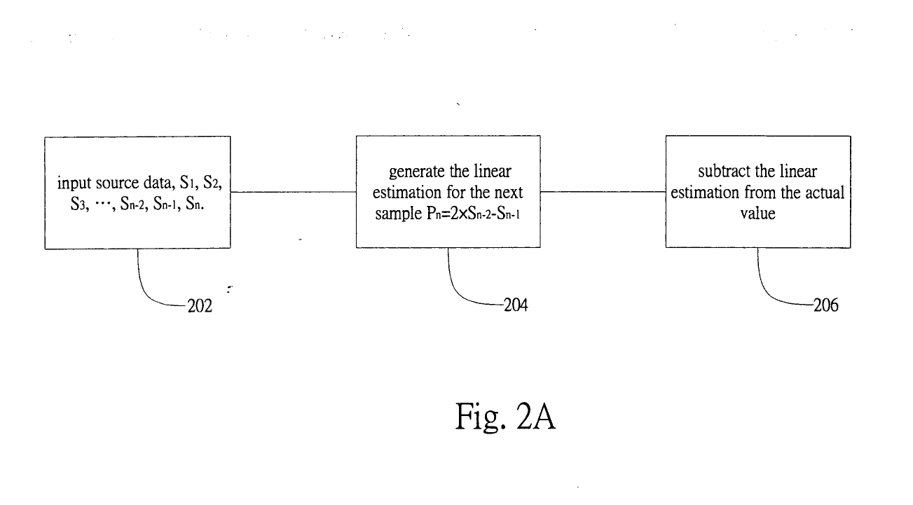

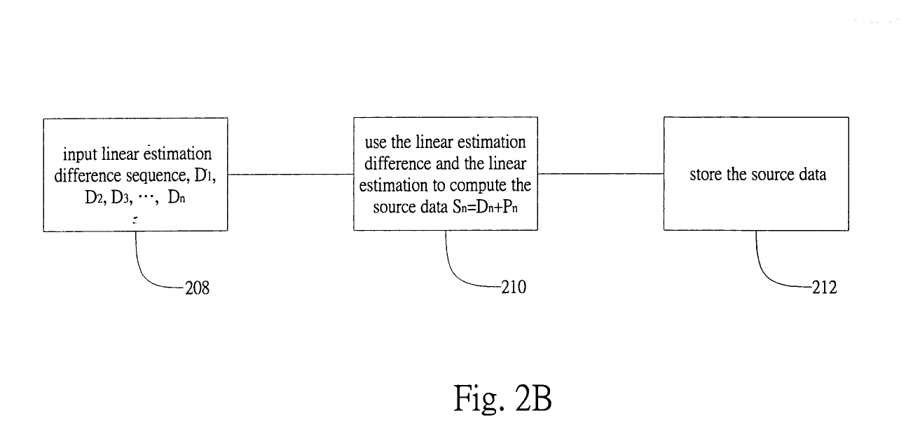

FIGS. 2A and 2B show flowcharts of encoding and decoding of a compression method in accordance with a second embodiment of the present invention. By utilizing the inter-dependency between the consecutive samples, this embodiment estimates the next sample linearly based on previous two consecutive samples, and obtains the difference between the estimation and the actual vale so as to reduce the number of bits required for data.

As shown in FIG. 2A, step 202 is to input source data, S₁, S₂, S₃, . . . , Sₙ₋₂, Sₙ₋₁, Sₙ. Step 204 is to use two consecutive samples to generate the linear estimation for the next sample Pₙ=2×Sₙ₋₂−Sₙ₋₁, and the sequence. Then, step 206 is to subtract the linear estimation from the actual value, and obtain a linear estimation difference Dₙ=Sₙ−Pₙ. Repeat the above computation to obtain the following sequences:

Linear estimation sequence: P₃=2×S₂−S₁, P₄=2×S₃−S₂, . . . , Pₙ=2×Sₙ₋₂−Sₙ₋₁;

Linear estimation difference sequence: D₃=S₃−P₃, D₄=S₄−P₄, . . . , Dₙ=Sₙ−Pₙ.

And finally, step 206 is to store the linear estimation difference sequence.

The decompression computation follows the reverse direction. As shown in FIG. 2B, step 208 is to input linear estimation difference sequence, D₁, D₂, D₃, . . . , Dₙ. Step 210 is to use the linear estimation difference and the linear estimation to compute the source data Sₙ=Dₙ+Pₙ. Repeat the above computation to obtain the following sequences:

Linear estimation sequence: P₃=2×S₂−S₁, P₄=2×S₃−S₂, . . . , Pₙ=2×Sₙ₋₂−Sₙ₋₁;

Source data: S₃=D₃+P₃, S₄=D₄+P₄, . . . , Sₙ=Dₙ+Pₙ.

And finally, step 212 is to store the source data.

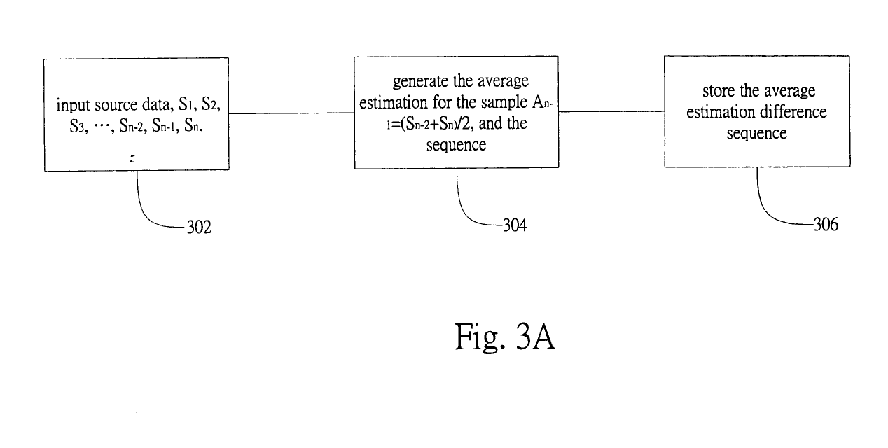

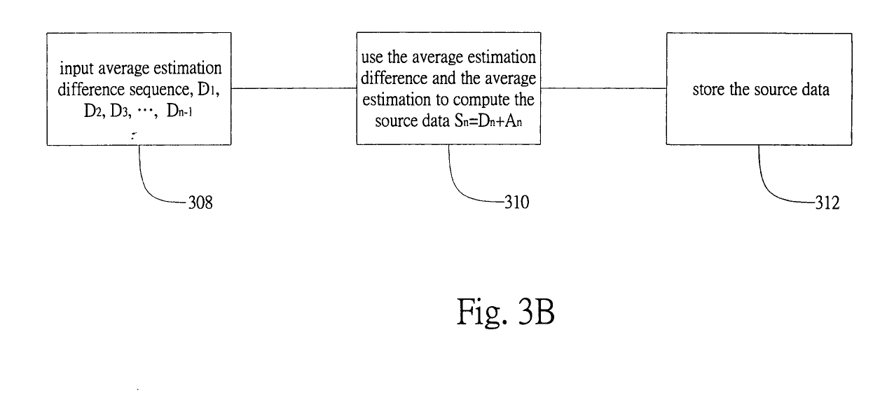

FIGS. 3A and 3B show flowcharts of encoding and decoding of a compression method in accordance with a third embodiment of the present invention. By utilizing the inter-dependency between the consecutive samples, this embodiment estimates the sample based on one prior sample and one next sample, and obtains the difference between the estimation and the actual vale.

As shown in FIG. 3A, step 302 is to input source data, S₁, S₂, S₃, . . . , Sₙ₋₂, Sₙ₋₁, Sₙ. Step 304 is to use one prior sample and one next sample to generate the average estimation for the sample Aₙ₋₁=(Sₙ₋₂+Sₙ)/2, and the sequence. Then, step 306 is to subtract the estimation from the actual value, and obtain an average estimation difference D_{n=S}ₙ−Aₙ. Repeat the above computation to obtain the following sequences:

Average estimation sequence: A₂=(S₁+S₃)/2, A₃=(S₂+S₄)/2, . . . , Aₙ₋₁=(Sₙ₋₂+Sₙ)/2;

Average estimation difference sequence: D₂=S₂−A₂, D₃=S₃−A₃, . . . , Dₙ₋₁=Sₙ₋₁−Aₙ₋₁.

And finally, step 306 is to store the average estimation difference sequence.

The decompression computation follows the reverse direction. As shown in FIG. 3B, step 308 is to input average estimation difference sequence, D₁, D₂, D₃, . . . , Dₙ₋₁. Step 310 is to use the average estimation difference and the average estimation to compute the source data Sₙ=Dₙ+Aₙ. Repeat the above computation to obtain the following sequences:

Average estimation sequence: A₂, A₃=S₃−D₃, . . . , Aₙ₋₁=Sₙ₋₁−Dₙ₋₁;

Source data: S₂=D₂+A₂, S₃=2×A₂−S₁, . . . , Sₙ=2×Aₙ₋₁−Sₙ₋₁.

And finally, step 312 is to store the source data.

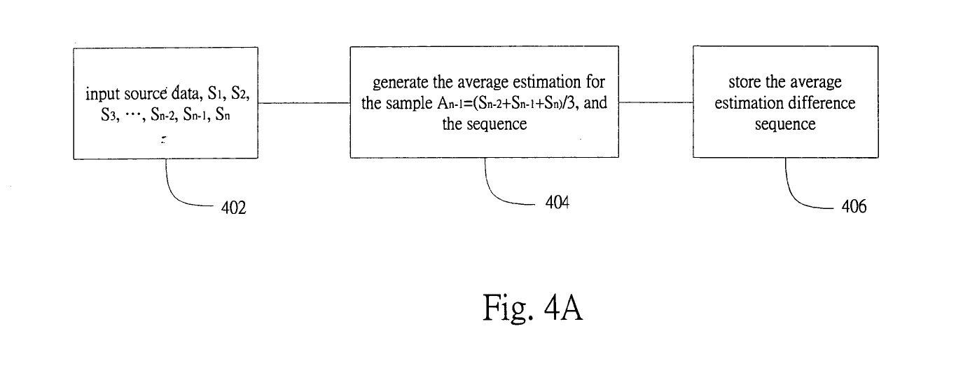

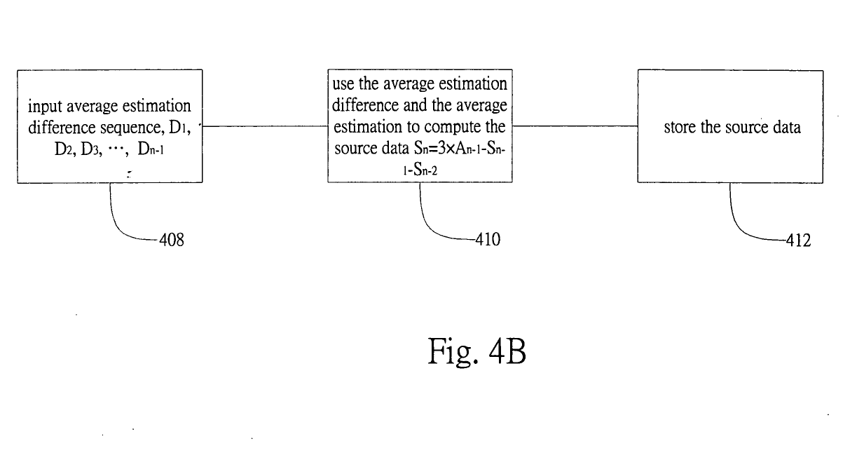

FIGS. 4A and 4B show flowcharts of encoding and decoding of a compression method in accordance with a fourth embodiment of the present invention. By utilizing the inter-dependency between the consecutive samples, this embodiment estimates the sample based on one prior sample, the sample itself and one next sample, and obtains the difference between the estimation and the actual vale.

As shown in FIG. 4A, step 402 is to input source data, S₁, S₂, S₃, . . . , Sₙ₋₂, Sₙ₋₁, Sₙ. Step 404 is to use one prior sample, the sample itself and one next sample to generate the average estimation for the sample Aₙ₋₁=(Sₙ₋₂+Sₙ₋₁+Sₙ)/3, and the sequence. Then, step 406 is to subtract the estimation from the actual value, and obtain an average estimation difference Dₙ₋₁=Sₙ₋₁−Aₙ₋₁. Repeat the above computation to obtain the following sequences:

Average estimation sequence: A₂=(S₁+S₂+S₃)/3, A₃=(S₂+S₃+S₄)/3, . . . , Aₙ₋₁=(Sₙ₋₂+Sₙ₋₁+Sₙ)/3;

Average estimation difference sequence: D₂=S₂−A₂, D₃=S₃−A₃, . . . , Dₙ₋₁=Sₙ₋₁−Aₙ₋₁.

And finally, step 406 is to store the average estimation difference sequence.

The decompression computation follows the reverse direction. As shown in FIG. 4B, step 408 is to input average estimation difference sequence, D₁, D₂, D₃, . . . , Dₙ₋₁. Step 410 is to use the average estimation difference and the average estimation to compute the source data Sₙ=3×Aₙ₋₁−Sₙ₋₁−Sₙ₋₂. Repeat the above computation to obtain the following sequences:

Average estimation sequence: A₂, A₃=S₃−D₃, . . . , Aₙ₋₁=Sₙ₋₁−Dₙ₋₁;

Source data: S₁, S₂=D₂+A₂, S₃=3×A₂−S₁−S₂, . . . , Sₙ=3×Aₙ₋₁−Sₙ₋₂−Sₙ₋₁.

And finally, step 412 is to store the source data

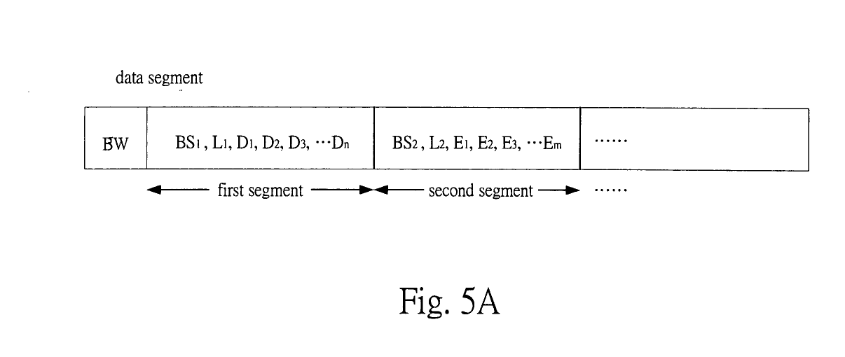

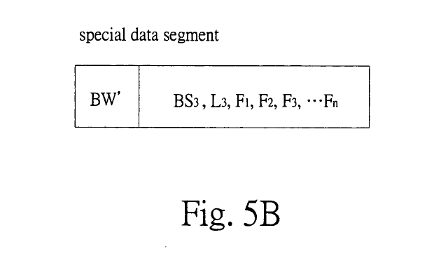

FIGS. 5A and 5B show a fifth embodiment of the present invention, including a method to use a fixed number of bits for representing data items in a segment to increase the compression and decompression efficiency. To use a compression data as an example, the compressed data includes one or more compressed items which can be a difference sequence made of first or higher level difference of the samples in a sample sequence. In this embodiment, the one or more compressed items will be represented by one or more representation items.

As shown in FIG. 5A, a data is divided into one or more segments, for example, a first segment and a second segment. The first segment includes a base value BS₁ and a segment length L₁. The representation items Dₙ, where n=1, 2, . . . , represent the deviations of the original data items from the base value. To make the representation items have the fixed length, a representation item D₁ with less bits than the fixed length BW will be padded with zeros. A plurality of representation items represents an original data.

On the other hand, if a representation item F₁ has more bits than the fixed length BW, a special data segment is established, a shown in FIG. 5B, where a special data segment uses the length BW' of the data item F₁ as the fixed length.

Referring to FIG. 5A, the base value BS of a segment is computed on the basis of all the data items in that segment in order to reduce the number of bits of the representation items. The BS of each segment can be different from each other, and BS can be one of the representation items of the segment, such as minimum, arithmetic average, median, geometric average, mode, or harmonic average. The segment length L can be the total number of the items in the segment or the total number of bits in the segment.

In addition, the computation of the fixed number of bits is as follows:

Second level difference sequence (representation item): E₁, E₂, . . . , Eₙ Let f(x)=y, where x is the second level difference, and y is the minimum number of bits of x. Assume that f(E₁)=B₁, f(E₂)=B₂, . . . , f(Eₙ)=Bₙ;

And
ΣB=B₁+B₂+ . . . +Bₙ
Then, BW_{sgst}=aZ+b.

In the above equation, the BW_{sgst} represents the suggested number of bits of this embodiment, which is the computed number of bits Z required by the first or higher level difference in the sample sequence, multiplied by a coefficient a, and plus a coefficient b. The computed Z can be any of the combination of (1) arithmetic average, (2) median, (3) geometric average, (4) mode, and (5) harmonic average of the sequence formed by the minimum number of bits for the representation items in the segment. The coefficient a is a chosen number, such as 3/2, and coefficient b can be the standard deviation of the sequence formed by the minimum number of bits for the representation items in the segment.

Arithmetic average:

$$\overline{B} = \sum \frac{B}{n} ,$$

for example,

$${BW}_{sgst} = \frac{3}{2} \overline{B} ,$$

Median:

$$Md = \frac{{B}_{n / 2} + {B}_{( \frac{n}{2} + 1 )}}{2} ,$$

for example,

$${BW}_{sgst} = \frac{3}{2} Md ,$$

Geometric average: G=ⁿ\sqrt{B₁·B₂·Λ·Bₙ}, for example,

$${BW}_{sgst} = \frac{3}{2} G ,$$

Mode: Mm, for example, BW_{sgst}=Mm+2,
Harmonic average:

$$H = \frac{1}{\frac{1}{n} \sum \frac{1}{{B}_{1}} + \frac{1}{{B}_{2}} + Λ + \frac{1}{{B}_{n}}} ,$$

for example,

$${BW}_{sgst} = \frac{3}{2} H ,$$

Standard deviation:

$$σ = \sqrt{\sum {( B - \overline{B} )}^{2} / n} ,$$

for example,

$${BW}_{sgst} = \overline{B} + σ ,$$

where

$$\sum {( B - \overline{B} )}^{2} = {( {B}_{1} - \overline{B} )}^{2} + {( {B}_{2} - \overline{B} )}^{2} + Λ + {( {B}_{n} - \overline{B} )}^{2} .$$

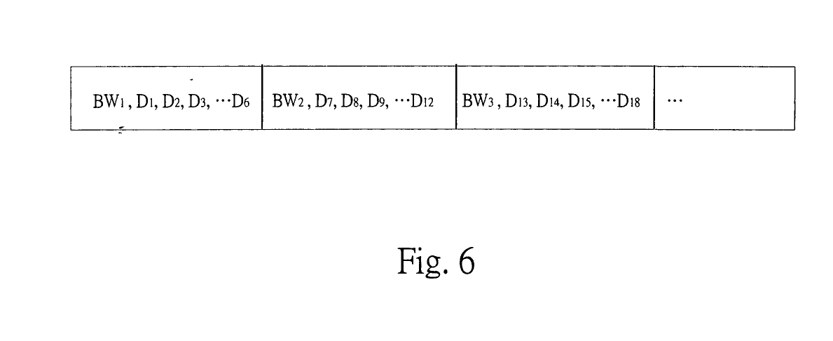

FIG. 6 shows a sixth embodiment of the present invention. A data for representation is divided into a plurality of segments, with each segment having a fixed length. The fixed length can be the total number of the representation items in the segment or the total number of bits in the segment (FIG. 6 shows that each segment has 6 representation items.) The fixed number of bits, BWₙ, where n=1, 2, . . . , of each segment is the maximum number of bits of all the representation items in the segment. Therefore, the fixed number of bits in segment can be different from each other.

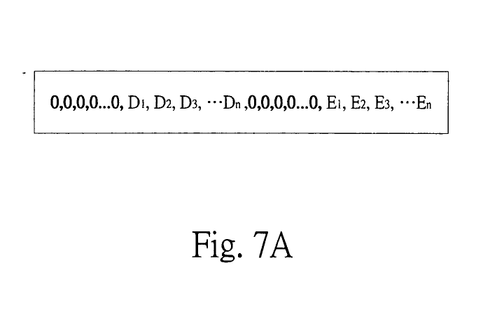

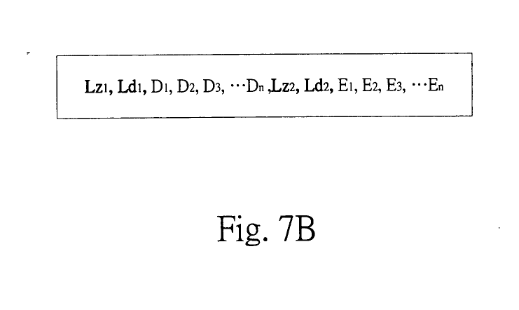

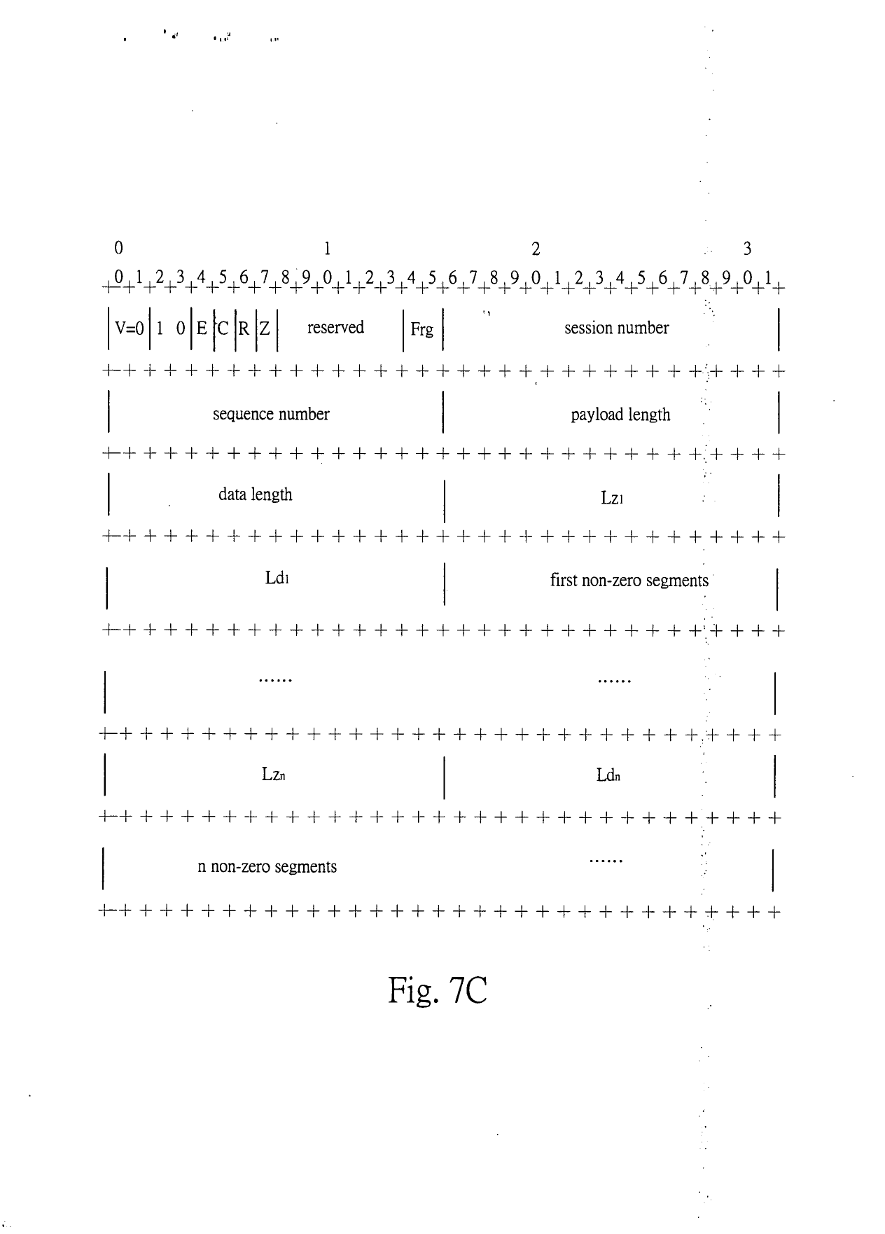

FIGS. 7A and 7B show a seventh embodiment of the present invention. In this embodiment, if a source data includes one or more consecutive segments of zeros, then as shown in FIG. 7A, the lengths of each consecutive zero segments are indicated by Lzₙ, where n=1, 2, . . . , and the lengths of each consecutive non-zero segments are indicated by Ldₙ, where n=1, 2, . . . . FIG. 7B shows the elimination of consecutive zero segments to form an encoded data, where the represented data can be either compressed or uncompressed.

The decompression method of this embodiment first reads the length Lzₙ, where n=1, 2, . . . , and pads the number of zeros indicated by Lzₙ, where n=1, 2, . . . Then, the method reads the length Ldₙ, where n=1, 2, . . . , and copies the number of data items from the encoded data indicated by Ldₙ, where n=1, 2, . . . . Repeat the above process until the encoded data is finished.

FIG. 7C shows the packet format of the seventh embodiment of the present invention. The packet includes the length the length Lzₙ where n=1, 2, . . . , Ldₙ, where n=1, 2, . . . , and the non-zero data, and so on.

While the invention has been described in connection with what is presently considered to the best modes, it is to be understood that the invention is not to be limited to the disclosed modes, but on the contrary, is intended to cover various modifications and equivalent arrangement included within the spirit and scope of the appended claims.

What is claimed is:

1. A method of data compression, applicable to data for transportation and storage, comprising the following steps of:
computing a first level difference, higher level difference or average of samples from a sample sequence or from a source data to obtain an estimate value of the sample;
computing the difference between the estimate value and an actual value of the sample; and
repeating above two steps to form a difference sequence of the sample sequence as a compressed data for transportation and storage.

2. The method as claimed in claim 1, wherein the first level difference, the higher level difference, or the average computation is based on two consecutive samples prior to the estimated sample for linear estimation.

3. The method as claimed in claim 1, wherein the first level difference, the higher level difference, or the average computation is based on one or more samples prior to the estimated sample, and one or more samples immediately following the estimated sample for average estimation.

4. The method as claimed in claim 1, wherein the first level difference, the higher level difference, or the average computation is based on one or more samples prior to the estimated sample, the estimated sample, and one ore more samples immediately following the estimated sample for average estimation.

5. The method as claimed in claim 1, wherein decompression is performed by using the difference between the estimate value and the actual value of the samples form the sequence to obtain the source data.

6. A method of representing data for transportation and storage, comprising the following steps of:
dividing a data into a plurality of data segments;
dividing each data segment into a plurality of segments;
computing a base value of the segment and values of all representation items in the segment to reduce the number of bits representing all the representation items in the segment, the base value of the segment may be different from each other;
setting length of each segment; and
setting a fixed number of bits to represent the representation items in the segment by using the following equation: BWsgst=aZ+b, where BWsgst is a suggested number of bits, Z is a computed number of bits, and a and b are coefficients.

7. The method as claimed in claim 6, wherein the data can be compressed or uncompressed data.

8. The method as claimed in claim 6, wherein the representation item in the data segment having less number of bits than the fixed number of bits of the data segment is padded with zeros so that the representation item has the same number of bits as the fixed number of bits of the data segment.

9. The method as claimed in claim 6, wherein a special data segment is established for the representation item in the data segment having more number of bits than the fixed number of bits of the data segment, the fixed number of bits of special data segment is the number of bits of the representation item.

10. The method as claimed in claim 6, wherein the length of the segment is the total number of the representation items in the segment or the total number of bits in the segment.

11. The method as claimed in claim 6, wherein the base value of the segment can be any combination of the following: minimum, arithmetic average, median, geometric average, mode, and harmonic average of all the representation items.

12. The method as claimed in claim 6, wherein the computed number of bits can be any combination of the following: arithmetic average, median, geometric average, mode and harmonic average of the sequence formed by the number of bits of all the representation items of the segment.

13. The method as claimed in claim 6, wherein the coefficients can be the standard deviation of the sequence formed by the number of bits of all the representation items of the segment.

14. The method as claimed in claim 6, wherein the representation items having the same fixed number of bits are placed consecutively.

15. A method of representing data for transportation and storage, comprising the following steps of:
dividing a data into a plurality of segments, each segment having a fixed segment length;
using the number of bits of the representation item with the maximum number of bits as a fixed number of bits for the segment; and
using the fixed number of bits to represent the representation items in the segment, padding the representation items having less number of bits than the fixed number of bits with zeros to equate the fixed number of bits.

16. The method as claimed in claim 15, wherein the representation items having the same fixed number of bits are placed consecutively.

17. The method as claimed in claim 15, wherein the length of the segment is the total number of the representation items in the segment or the total number of bits in the segment.

18. A method of data compression for transportation and storage, comprising the steps of:
a compressing data step, by marking a length of a consecutive zero segment and a length of a consecutive non-zero data segment in the data, repeating the marking through entire the data, eliminating the consecutive zero segment from the data to form encoded data; and
a decompressing data step, by reading the length of the consecutive zero segment, padding zeros according the length of the consecutive zero segment, reading the length of the consecutive non-zero data segment, copying representation items from the data according to the length of the consecutive non-zero segment, repeating until finishing entire the encoded data.

19. The method as claimed in claim 18, wherein the data can be compressed or uncompressed data.
